(19) United States
(12) Patent Application Publication
(10) Pub. No.: US 2026/0121835 A1
(43) Pub. Date: Apr. 30, 2026

(54) FLASH MEMORY CONTROLLER AND BLOCK CIPHER METHOD FOR USING SINGLE ONE MULTIPLIER TO SUPPORT TWO DIFFERENT KINDS OF BLOCK CIPHER SCHEMES

(71) Applicant: Silicon Motion, Inc., Hsinchu County (TW)

(72) Inventors: Wen-Long Wang, Hsinchu City (TW); Hung-Hsien Lee, New Taipei City (TW)

(73) Assignee: Silicon Motion, Inc., Hsinchu County (TW)

(21) Appl. No.: 18/926,339

(22) Filed: Oct. 25, 2024

(51) Int. Cl. H04L 9/06

(52) U.S. Cl. CPC H04L 9/0631

(57) ABSTRACT

A block cipher method of a flash memory controller includes: encrypting a seed value to generate an encrypted seed value in a first/second block cipher mode according to a second key; multiplying the encrypted seed value with α^{j} according to a mode selection signal to generate a j-th multiplication result; performing a first XOR operation upon the j-th multiplication result and a j-th plaintext block to generate a first XOR result; encrypting the first XOR result to generate an encrypted XOR result in the first/second block cipher mode according to a first key; and, performing a second XOR operation upon the j-th multiplication result and the encrypted XOR result to generate a second XOR result as a j-th ciphertext block; the multiplying step operating in the first/second block cipher mode is determined by either the mode selection signal generated from a microcontroller or recorded in a 0-th plaintext block.

### BACKGROUND OF THE INVENTION

### 1. Field of the Invention

The invention relates to a cipher scheme, and more particularly to a flash memory controller and a corresponding block cipher method.

### 2. Description of the Prior Art

Generally speaking, a conventional block cipher method needs to use two multiplier circuits to respectively support two different kinds of block cipher schemes, and this inevitably increases the circuit costs.

### SUMMARY OF THE INVENTION

Therefore one of the objectives of the invention is to provide a flash memory controller and a corresponding block cipher method, to solve the above-mentioned problems.

According to an embodiment of the invention, a flash memory controller, to be coupled between a host device and a flash memory device, is disclosed. The flash memory controller comprises a microcontroller and an encryption circuit. The encryption circuit, coupled to the microcontroller, comprises a first encryption circuit, a second encryption circuit, a multiplier, a first exclusive-OR (XOR) circuit, a third encryption circuit, a fourth encryption circuit, and a second XOR circuit. The first encryption circuit is used for encrypting a seed value to generate an encrypted seed value in a first block cipher mode according to a second key. The second encryption circuit is used for encrypting the seed value to generate an encrypted seed value in a second block cipher mode according to the second key. The multiplier, coupled to the first encryption circuit and the second encryption circuit, is used for multiplying the encrypted seed value, generated in the first block cipher mode or in the second block cipher mode, with a specific value α^{j} according to a mode selection signal to generate a j-th multiplication result, and the a is a primitive element corresponding to a polynomial of a finite field multiplier. The first XOR circuit, coupled to the multiplier, is used for performing a first XOR operation upon the j-th multiplication result and a j-th plaintext block to generate a first XOR result, and a data unit sent from the host device and to be written into the flash memory device is received by the flash memory controller and includes a sequence of plaintext blocks in which the j-th plaintext block is included. The third encryption circuit, coupled to the first XOR circuit, is used for encrypting the first XOR result to generate an encrypted XOR result in the first block cipher mode according to a first key. The fourth encryption circuit, coupled to the first XOR circuit, is used for encrypting the first XOR result to generate the encrypted XOR result in the second block cipher mode according to the first key. The second XOR circuit, coupled to the multiplier, the third encryption circuit, and the fourth encryption circuit, is used for performing a second XOR operation upon the j-th multiplication result and the encrypted XOR result which is generated in the first block cipher mode or in the second block cipher mode so as to generate a second XOR result as a j-th ciphertext block which is written into the flash memory device. The multiplier operating in the first block cipher mode or in the second block cipher mode is determined by either the mode selection signal generated from the microcontroller or the mode selection signal recorded in a 0-th plaintext block in the sequence of plaintext blocks.

According to another embodiment of the invention, a block cipher method of a flash memory controller to be coupled between a host device and a flash memory device is disclosed. The block cipher method comprises: providing a first encryption circuit for encrypting a seed value to generate an encrypted seed value in a first block cipher mode according to a second key; providing a second encryption circuit for encrypting the seed value to generate an encrypted seed value in a second block cipher mode according to the second key; multiplying the encrypted seed value, generated in the first block cipher mode or in the second block cipher mode, with a specific value α^{j} according to a mode selection signal to generate a j-th multiplication result, α being a primitive element corresponding to a polynomial of a finite field multiplier; performing a first XOR operation upon the j-th multiplication result and a j-th plaintext block to generate a first XOR result, a data unit sent from the host device and to be written into the flash memory device being received by the flash memory controller and including a sequence of plaintext blocks in which the j-th plaintext block is included; providing a third encryption circuit for encrypting the first XOR result to generate an encrypted XOR result in the first block cipher mode according to a first key; providing a fourth encryption circuit for encrypting the first XOR result to generate the encrypted XOR result in the second block cipher mode according to the first key; and, performing a second XOR operation upon the j-th multiplication result and the encrypted XOR result which is generated in the first block cipher mode or in the second block cipher mode so as to generate a second XOR result as a j-th ciphertext block which is written into the flash memory device; the multiplying step operating in the first block cipher mode or in the second block cipher mode is determined by either the mode selection signal generated from a microcontroller of the flash memory controller or the mode selection signal recorded in a 0-th plaintext block in the sequence of plaintext blocks.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a flash memory controller according to an embodiment of the invention.

FIG. 2 is a diagram showing the operation of the multiplier shown in FIG. 1 according to an embodiment of the invention.

FIG. 3 is a circuit diagram of the multiplier in FIG. 1 according to an embodiment of the invention.

FIG. 4 is a diagram of a flash memory controller according to another embodiment of the invention.

FIG. 5 is a circuit diagram of the multiplier in FIG. 4 according to an embodiment of the invention.

### DETAILED DESCRIPTION

The invention aims at providing a flash memory controller and a block cipher method capable of using a single one multiplier circuit to support two different kinds of block cipher schemes. This can significantly reduce the circuit costs.

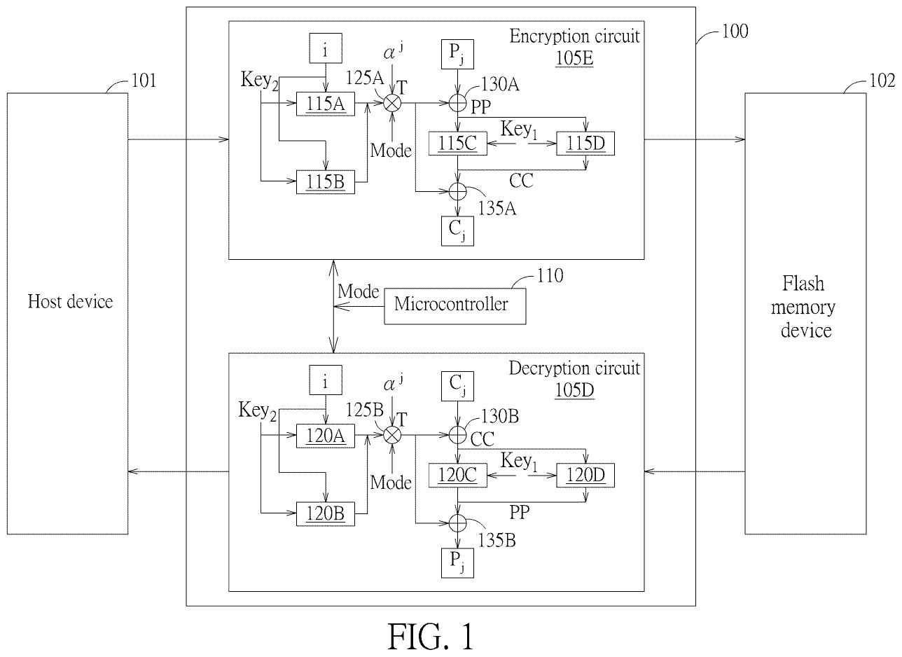

FIG. 1 is a diagram of a flash memory controller 100 according to an embodiment of the invention. The flash memory controller 100 is to be coupled between the host device 101 such as a personal computer device and one or more flash memory devices 102 such as NAND-type flash memory chips/dies. The flash memory controller 100 for example comprises an encryption circuit 105E, a decryption circuit 105D, and a microcontroller 110 which is coupled to and used for controlling the encryption circuit 105E and decryption circuit 105D.

For the encryption operation, the key is parsed as a concatenation of two fields of equal size keys Key₁ and Key₂. The encryption circuit 105E uses two keys Key₁ and Key₂ to perform a block cipher encryption to protect data sent from the host device 101 and to be written into a page of the flash memory device 102, and it can support two different kinds of encryption schemes (e.g. operations/modes). Alternatively, the decryption circuit 105D uses two corresponding keys Key₁ and Key₂ to perform a block decipher decryption to obtain correct information from the data read from the page of the flash memory device 102 so as to send the correct information to the host device 101 if the host device 101 requests the correct information, and it can support two different kinds of corresponding decryption schemes.

In practice, the encryption circuit 105E comprises a first encryption circuit 115A supporting a first block cipher scheme, a second encryption circuit 115B supporting a second block cipher scheme, a third encryption circuit 115C supporting the first block cipher scheme, a fourth encryption circuit 115D supporting the second block cipher scheme, a single one multiplier 125A, a first exclusive-OR (XOR) circuit 130A, and a second XOR circuit 135A. The first block cipher scheme is for example (but not limited) XTS-AES (XEX-based Tweaked-codebook mode with ciphertext Stealing) scheme that is a mode of operation for AES (Advanced Encryption Standard) which is a symmetric block cipher used to encrypt and decrypt data and is provided and specified in the IEEE standard. The second block cipher scheme is for example (but not limited) SM4 (ShāngMì 4) scheme that is a symmetric block cipher which is provided by the Chinese National Standard for cryptographic algorithms.

Similarly, the decryption circuit 105D comprises a fifth encryption circuit 120A supporting the first block cipher scheme, a sixth encryption circuit 120B supporting the second block cipher scheme, a first decryption circuit 120C supporting the first block cipher scheme, a second decryption circuit 120D supporting the second block cipher scheme, a single one multiplier 125B, a third exclusive-OR (XOR) circuit 130B, and a fourth XOR circuit 135B.

In this embodiment, the microcontroller 110 respectively sends a mode selection signal Mode into the encryption circuit 105E and decryption circuit 105D to select one mode among two different kinds of modes of different block cipher schemes. For example, the encryption circuit 105E has the two cipher modes such as a first block cipher mode corresponding to XTS-AES scheme and a second block cipher mode corresponding to SM4 scheme. The operations of encryption circuits 115A and 115C are associated with the XTS-AES scheme (i.e. the first block cipher mode), and the operations of encryption circuit 115B and 115D are associated with the SM4 scheme (i.e. the second block cipher mode). The operations of the multiplier 125A, bitwise XOR circuits 130A and 135A are shared to be use by both the XTS-AES scheme (i.e. the first block cipher mode) and SM4 scheme (i.e. the second block cipher mode). Similarly, in the decryption circuit 105D, the operations of encryption circuit 120A and decryption circuit 120C are associated with the XTS-AES scheme (i.e. the first block cipher mode), and the operations of encryption circuit 120B and decryption 120D are associated with the SM4 scheme (i.e. the second block cipher mode). The operations of the multiplier 125B, bitwise XOR circuits 130B and 135B are shared to be use by both the XTS-AES scheme (i.e. the first block cipher mode) and SM4 scheme (i.e. the second block cipher mode).

For data encryption, the flash memory controller 100 receives a sequence of data units such as sectors to be written into the flash memory device 102, and the sequence of data units are regarded as the plaintext data for the encryption circuit 105E; the encryption circuit 105E is used to encrypt the plaintext data as the ciphertext data and then write the ciphertext data into the flash memory device 102 so as to protect the sequence of data units. For example, Pⱼ is the j-th block of the plaintext data (i.e. a plaintext block) sent from the host device 101 and received by the flash memory controller 100. A plaintext block for example has a length of 128 bits (but not limited), and a data unit such as a data sector may comprise a sequence of plaintext blocks P₁, P₂, . . . , Pₘ. Cⱼ is the j-th block of ciphertext data which is finally written into the flash memory device 102 and for example is called as the j-th ciphertext block having a length of 128 bits, and the value j is the sequence number of the 128-bit blocks within a data sector. Inversely, for data decryption, the flash memory controller 100 reads a sequence of data units from the flash memory device 102, and the decryption circuit 105D for example decrypts the ciphertext data (e.g. the j-th ciphertext block) to generate the plaintext data (i.e. the j-th plaintext block) and to send the plaintext data, requested by the host device 101, to the host device 101.

When the microcontroller 110 of the flash memory controller 100 selects the first block cipher mode corresponding to the AES encryption scheme, the first encryption circuit 115A performs an AES encryption to encrypt the seed value i such as a value of a 128-bit tweak data based on the key Key₂ in the first block cipher mode to generate an encrypted seed value E(Key₂, i) of the j-th block into the multiplier 125A. Each sector is assigned a corresponding tweak value i that is a nonnegative integer. The tweak values can be assigned consecutively. In this situation, the encryption circuit 115B corresponding to the SM4 encryption scheme does not work, i.e. its operation is disabled. The multiplier 125A is a Galois Field (GF) multiplier which is a finite field used in cryptography, and is for example GF(2^{m}); the value 2 is a prime number and m is a positive integer such as 128. The multiplication is performed modulo a primitive polynomial of degree 128. The value α is a primitive element of GF(2¹²⁸) corresponding to polynomial x, and α^{j} is multiplied by itself j times in GF(2¹²⁸). The multiplier 125A multiplies the encrypted seed value E(Key₂, i) of the j-th block with the specific value α^{j} to generate a j-th multiplication result T=E(Key₂, i)⊗α^{j}. The first XOR circuit 130A performs the first XOR operation upon the j-th plaintext block Pⱼ and the j-th multiplication result T=E(Key₂, i)⊗α^{j} to generate a first XOR result PP=Pⱼ⊕T, and then the third encryption circuit 115C in the first block cipher mode performs the AES encryption to encrypt the first XOR result PP=Pⱼ⊕T based on the key Key₁ to generate an encrypted XOR result CC=E(Key₁, PP) of the j-th block. Then, the second XOR circuit 135A performs the second XOR operation upon the encrypted XOR result CC=E(Key₁, PP) of the j-th block and the j-th multiplication result T=E(Key₂, i)⊗α^{j} to generate a second XOR result as the j-th ciphertext block Cⱼ. It should be noted that in this situation the fourth encryption circuit 115D corresponding to the SM4 encryption scheme is also disabled.

For the second block cipher mode corresponding to the SM4 encryption scheme, the operations of encryption circuits 115A and 115C are disabled, and the operation of encryption circuits 115B and 115D are enabled. The flash memory controller 100 selects the second block cipher mode corresponding to the SM4 encryption scheme, and the second encryption circuit 115B in the second block cipher mode performs the SM4 encryption to encrypt the seed value i based on the key Key₂ to generate an encrypted seed value E(Key₂, i) of the j-th block into the multiplier 125A. The multiplier 125A multiplies the encrypted seed value E(Key₂, i) of the j-th block with the value α^{j} to generate the j-th multiplication result T=E(Key₂, i)⊗α^{j}. The XOR circuit 130A performs the first XOR operation upon the j-th plaintext block Pⱼ and the j-th multiplication result T=E(Key₂, i)⊗α^{j} to generate the first XOR result PP=Pⱼ⊕T, and then the fourth encryption circuit 115D in the second block cipher mode performs the SM4 encryption to encrypt the first XOR result PP=Pⱼ⊕T based on the key Key₁ to generate the encrypted XOR result CC=E(Key₁, PP) of the j-th block. Then, the second XOR circuit 135A performs the second XOR operation upon the encrypted XOR result CC=E(Key₁, PP) of the j-th block and the j-th multiplication result T=E(Key₂, i)⊗α^{j} to generate the j-th ciphertext block Cⱼ. That is, the multiplier 125A in the encryption circuit 105E is a single one multiplier to be shared and used by both the different kinds of encryption schemes.

Correspondingly, the flash memory controller 100 reads a sequence of data units such as sectors from the flash memory device 102, and the sequence of data units are regarded as the ciphertext data for the decryption circuit 105D. In this situation, Cⱼ is the j-th block of ciphertext data which is read from the flash memory device 102 and for example is called as the j-th ciphertext block having a length of 128 bits, and the value j is the sequence number of the 128-bit ciphertext blocks within a data sector.

For the AES decryption, when the flash memory controller 100 selects the first block cipher mode corresponding to the AES decryption scheme, the fifth encryption circuit 120A in the first block cipher mode performs the AES encryption to encrypt the seed value i such as a value of a 128-bit tweak data based on the key Key₂ to generate an encrypted seed value E(Key₂, i) of the j-th block into the multiplier 125B. The multiplier 125B is for example GF(2^{m}), and the value 2 is a prime number and m is a positive integer such as 128. The multiplier 125B multiplies the encrypted seed value E(Key₂, i) of the j-th ciphertext block with the specific value α^{j} to generate a j-th multiplication result T=E(Key₂, i)⊗α^{j}. The third XOR circuit 130B performs the third XOR operation upon the j-th ciphertext block Cⱼ and the j-th multiplication result T=E(Key₂, i)⊗α^{j} to generate a third XOR result CC=Cⱼ⊕T, and then the first decryption circuit 120C in the first block cipher mode performs the AES decryption to decrypt the third XOR result CC=Cⱼ⊕T based on the key Key₁ to generate an decrypted XOR result PP=D(Key₁, CC) of the j-th block. Then, the second XOR circuit 135B performs the XOR operation upon the decrypted XOR result PP=D(Key₁, CC) of the j-th block and the j-th multiplication result T=E(Key₂, i)⊗α^{j} to generate a fourth XOR result as the j-th plaintext block Pⱼ. It should be noted that in this situation the sixth encryption circuit 120B and the second decryption circuit 120D are disabled.

For the SM4 decryption, the operations of fifth encryption circuit 120A and first decryption circuit 120C are disabled, and the operations of sixth encryption circuits 120B and second decryption circuit 120D are enabled. Similarly, when the flash memory controller 100 selects the second block cipher mode corresponding to the SM4 decryption scheme, the sixth encryption circuit 120B in the second block cipher mode performs the SM4 encryption to encrypt the seed value i such as a value of a 128-bit tweak data based on the key Key₂ to generate an encrypted seed value E(Key₂, i) of the j-th block into the multiplier 125B. The multiplier 125B multiplies the encrypted seed value E(Key₂, i) of the j-th ciphertext block with the value α^{j} to generate a j-th multiplication result T=E(Key₂, i)⊗α^{j}. The third XOR circuit 130B performs the third XOR operation upon the j-th ciphertext block Cⱼ and the j-th multiplication result T=E(Key₂, i)⊗α^{j} to generate the third XOR result CC=Cⱼ⊕T, and then the second decryption circuit 120D in the second block cipher mode performs the SM4 decryption to decrypt the third XOR result CC=Cⱼ⊕T based on the key Key₁ to generate an decrypted XOR result PP=D(Key₁, CC) of the j-th block. Then, the fourth XOR circuit 135B performs the fourth XOR operation upon the decrypted XOR result PP=D(Key₁, CC) of the j-th block and the j-th multiplication result T=E(Key₂, i)⊗α^{j} to generate the fourth XOR result as the j-th plaintext block Pⱼ.

By doing so, only one multiplier is needed for both the AES encryption and SM4 encryption operations, and only one multiplier is needed for both the AES decryption and SM4 decryption operations. The circuit costs can be effectively reduced.

Further, in other embodiments, the encryption circuit 105E and decryption circuit 105D can be integrated as a single block cipher circuit which can respectively perform encryption and decryption operations. For example (but not limited), for implementation, in one embodiment, the operations of first decryption circuit 120C and second decryption circuit 120D can be respectively installed into the third encryption circuit 115C and fourth encryption circuit 115D to configure the circuits 115C and 115D as the circuits having both the encryption and decryption functions, and the encryption circuit 105E after modified can have the decryption functions identical to those of decryption circuit 105D; that is, the decryption circuit 105D can be optional and may be excluded from the flash memory controller 100. Therefore, only one multiplier 125A is required to support both the AES decryption and SM4 encryption operations and both the AES decryption and SM4 decryption operations. This modification also falls within the scope of the invention.

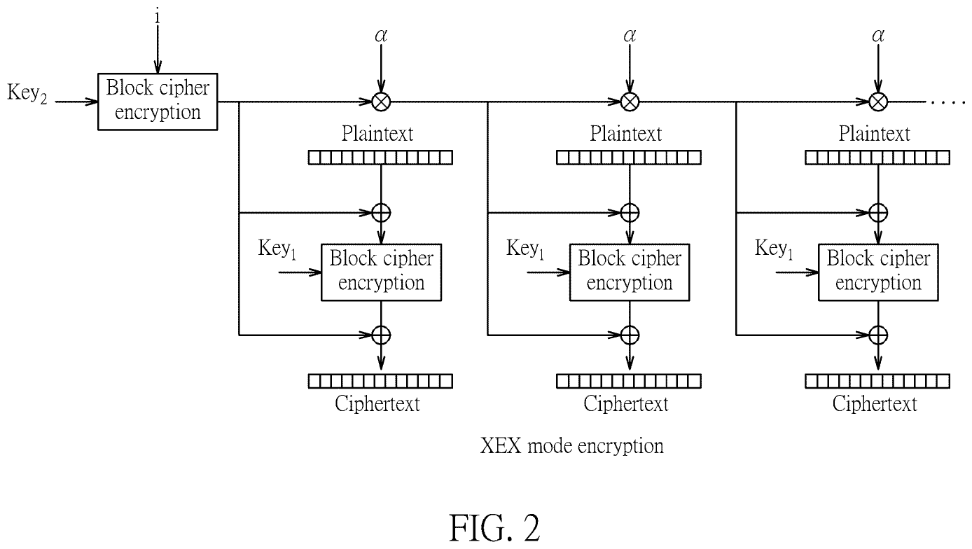

FIG. 2 is a diagram showing the operation of the multiplier such as 125A shown in FIG. 1 according to an embodiment of the invention. In FIG. 2, for the XEX mode encryption, the operation of the multiplier 125A is a series of the multiplications of the value α. For the j-th plaintext block wherein j is zero (i.e. the 0-th plaintext block), the value α^{j}=α⁰=1, and for example a block cipher encryption, such as the operation of AES encryption circuit 115A in the first block cipher mode, is used to encrypt the assigned seed value i by using the key Key₂ to generate the encrypted seed value as the 0-th multiplication result T=E(Key₂, i) since the value α^{j}=α⁰=1; that is, the operation of multiplier 125A is bypassed in this situation. That is, the multiplier such as 125A is bypassed when generating the 0-th multiplication result, and the encrypted seed value generated in the first block cipher mode or in the second block cipher mode can be directly used as the 0-th multiplication result. The 0-th multiplication result then is XORed with the corresponding plaintext block (i.e. the 0-th plaintext block) to generate the first XOR result, and the first XOR result then is to be encrypted by the block cipher encryption such as the operation of AES encryption circuit 115C in FIG. 1 based on the key Key₁ to generate the encrypted XOR result which is then to be XORed with the 0-th multiplication result (in this situation it is the encrypted seed value since α^{j}=α⁰=1) to generate the second XOR result as the 0-th ciphertext block. That is, for the 0-th block cipher encryption, the multiplier 125A can be bypassed.

The other block cipher encryptions for the following plaintext blocks are not bypassed. For the j-th plaintext block wherein j is one (i.e. the 1-th plaintext block), the value α^{j}=α¹=α, and for example the encrypted seed value E(Key₂, i), which is encrypted by using the key Key₂ for the 0-th block cipher encryption, can be transmitted to the multiplier 125A to be multiplied by the value α to generate the 1-th multiplication result T=E(Key₂, i)⊗α^{j} which is to be XORed with the corresponding plaintext block (i.e. the 1-th plaintext block) to generate the first XOR result. The first XOR result then is to be encrypted by the block cipher encryption based on the key Key₁ to generate the encrypted XOR result which is then to be XORed with the 1-th multiplication result T=E(Key₂, i)⊗α^{j} to generate the second XOR result as the 1-th ciphertext block.

Then, for the j-th plaintext block wherein j is two (i.e. the 2-th plaintext block), the value α^{j}=α²=α×α, and for example the 1-th multiplication result T=E(Key₂, i)⊗α¹, can be transmitted to the multiplier 125A to be multiplied by the value α again to generate a 2-th multiplication result T=E(Key₂, i)⊗α² which is to be XORed with the corresponding plaintext block (i.e. the 2-th plaintext block) to generate the first XOR result. The first XOR result then is to be encrypted by the block cipher encryption based on the key Key₁ to generate the encrypted XOR result which is then to be XORed with the 2-th multiplication result T=E(Key₂, i)⊗α² to generate the 2-th ciphertext block. That is, the multiplier 125A can directly multiply the (j−1)-th multiplication result T=E(Key₂, i)⊗α^{j-1} with the value α to generate the j-th multiplication result T=E(Key₂, i)⊗α^{j}. The operations of the multiplier 125B in the decryption circuit 105D are similar to those of the multiplier 125A in the encryption circuit 105E and are not detailed.

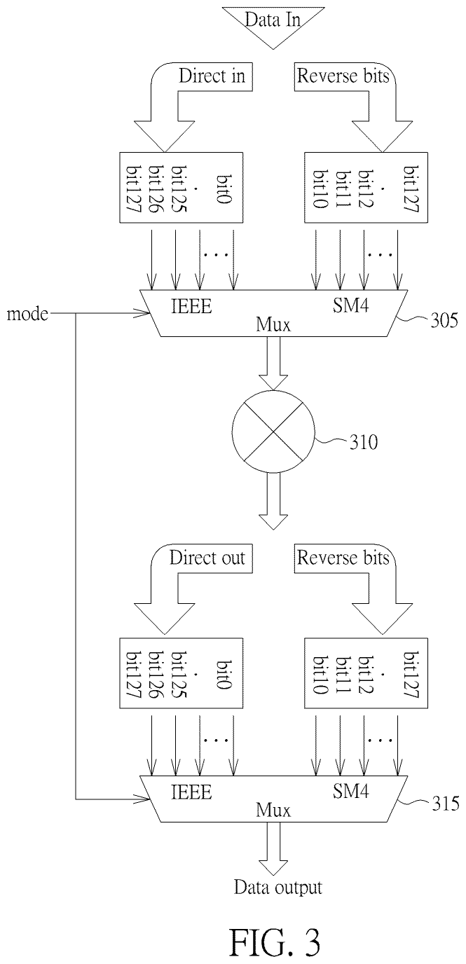

FIG. 3 is a circuit diagram of the multiplier 125A in FIG. 1 according to an embodiment of the invention. The multiplier 125A comprises first multiplexer 305 having first input portion corresponding to ‘IEEE’ and second input portion corresponding to ‘SM4’, a multiplication circuit 310, and a second multiplexer 315 having third input portion corresponding to ‘IEEE’ and fourth input portion corresponding to ‘SM4’. The multiplication circuit 310 is a GF(2¹²⁸) multiplier for AES encryption/decryption scheme, and can be used to multiply two polynomials, e.g. the 128-bit value representing the value α (e.g. 0000 . . . 010₂) and the 128-bit value representing the encrypted seed value, based on the binary arithmetic, and then to reduce the multiplication result module an irreducible polynomial (e.g. x¹²⁸+x⁷+x²+x+1, but not limited) to make the multiplication result fit within 128 bits. The microcontroller 110 sends the mode selection signal Mode to control the operations of first multiplexer 305 and second multiplexer 315.

For generating the 0-th multiplication result, the multiplier such as 125A is bypassed, and the encrypted seed value generated in the first block cipher mode or in the second block cipher mode can be directly used as the 0-th multiplication result.

For generating the 1-th multiplication result, for example, the multiplication circuit 310 is a GF(2¹²⁸) multiplier for AES encryption/decryption scheme, and in the first block cipher mode, the first multiplexer 305 can select and output the sequence of bits (i.e. the 128 bits from bit0 to bit127 representing the 0-th multiplication result) generated from the first encryption circuit 115A and directly inputted to the first input portion corresponding to ‘IEEE’, as a sequence of first output bits according to the mode selection signal Mode sent from the microcontroller 110. Thus, in the first block cipher mode, the multiplication circuit 310 can correctly multiply the two polynomials, e.g. the 128-bit value representing the value α (e.g. 0000 . . . 010₂) and the 128-bit value representing the sequence of first output bits to generate the sequence of multiplication result bits which fits within 128 bits. According to the mode selection signal Mode sent the from microcontroller 110, the second multiplexer 315 in the first block cipher mode directly selects the sequence of multiplication result bits (i.e. the corresponding 128 bits corresponding to ‘IEEE’) as a sequence of second output bits which is used as the 1-th multiplication result.

Alternatively, in the second block cipher mode, foe generating the 1-th multiplication result, the first multiplexer 305 can performing an order-reversed operation upon another sequence of bits generated from the second encryption circuit 115B to generate and select an order-reversed sequence of bits (i.e. the bits from bit127 to bit0) corresponding to ‘SM4’ as the sequence of first output bits. That is, the orders of the 128 bits from bit0 to bit127, representing the 1-th multiplication result generated from the second encryption circuit 115B are sequentially reversed to generate the order-reversed 128 bits i.e. the bits from bit127 to bit, and then order-reversed 128 bits from bit127 to bit0 are respectively inputted into the second input portion of the first multiplexer 305, so that the first multiplexer 305 can select and output the order-reversed 128 bits corresponding to ‘SM4’ as the sequence of first output bits that is to be outputted to the multiplication circuit 310 according to the mode selection signal Mode sent from the microcontroller 110.

Thus, in the second block cipher mode, the multiplication circuit 310 belonging to the AES encryption/decryption scheme is still used to perform the same multiplying operation, i.e. multiplying the two polynomials, e.g. the 128-bit value representing the value α (e.g. 0000 . . . 010₂) and the sequence of first output bits (in this situation it is the sequence of order-reversed 128 bits) to generate the sequence of multiplication result bits. Then, the second multiplexer 315 in the second block cipher mode can perform another order-reversed operation upon the sequence of multiplication result bits to generate and select another order-reversed sequence of bits corresponding to ‘SM4’ as the sequence of second output bits which is used as the 1-th multiplication result. That is, the orders of 128 bits of the multiplication result bits is reversed again to generate the 1-th multiplication result in the SM4 encryption/decryption scheme.

Similarly, for generating the j-th multiplication result, the first multiplexer 305 can directly select a sequence of bits of a (j−1)-th multiplication result as the sequence of first output bits when the mode selection signal Mode indicates the first block cipher mode, and can perform the order-reversed operation upon the sequence of bits of the (j−1)-th multiplication result to generate and select the order-reversed sequence of bits as the sequence of first output bits when the mode selection signal Mode indicates the second block cipher mode. The multiplication circuit 310 corresponding to the cipher operation of the first block cipher mode is used to multiply the sequence of first output bits with the sequence of bits representing α to generate the sequence of multiplication result bits. The second multiplexer 315 can directly select the sequence of multiplication result bits as the sequence of second output bits which is used as the j-th multiplication result when the mode selection signal Mode indicates the first block cipher mode, and can perform the another order-reversed operation upon the sequence of multiplication result bits to generate and select the another order-reversed sequence of bits as the sequence of second output bits which is used as the j-th multiplication result when the mode selection signal Mode indicates the second block cipher mode.

By doing so, even the multiplication circuit 310 is originally not suitable for SM4 encryption/decryption scheme, however, based on the operations of bit order reversions and two multiplexers 305 and 315, the multiplication circuit 310 equivalently can be suitable for SM4 encryption/decryption scheme. Thus, the single one multiplier 125A be applied into can both the SM4 encryption/decryption scheme and AES encryption/decryption scheme. Similarly, the single one multiplier 125B can be also applied into both the SM4 encryption/decryption scheme and AES encryption/decryption scheme.

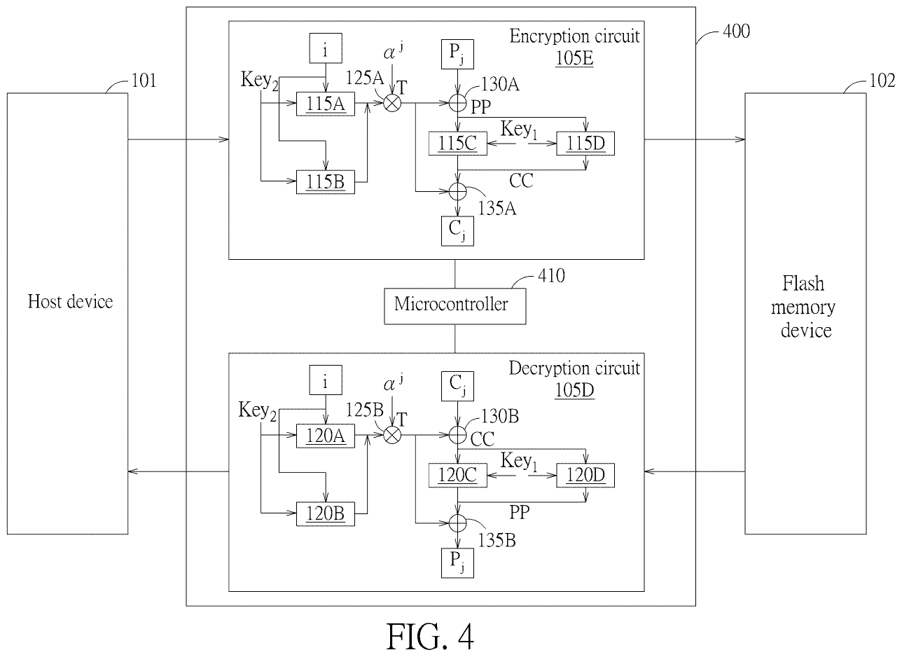

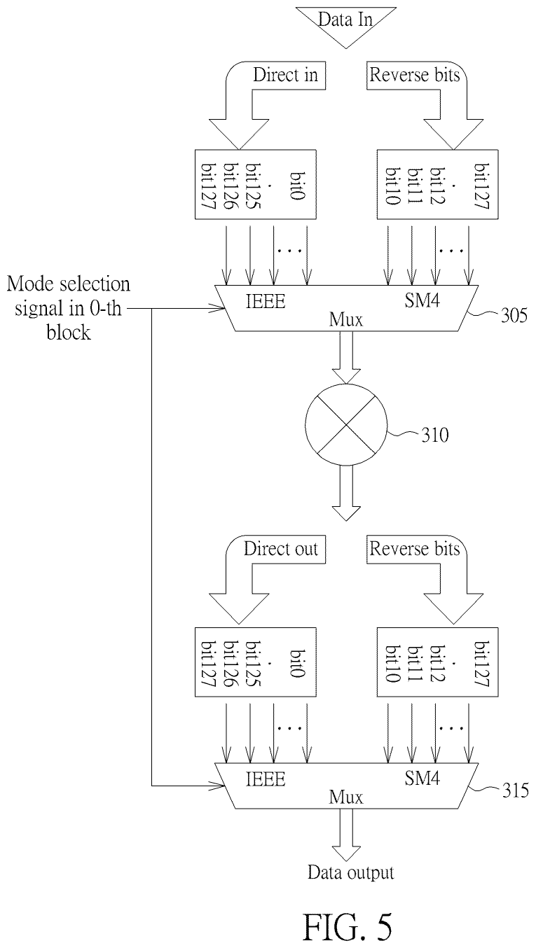

In other embodiments, a microcontroller sending the mode selection signal Mode can be optional. That is, the mentioned multiplier operating in the first block cipher mode or in the second block cipher mode can be determined by either the mode selection signal generated from the microcontroller or the mode selection signal recorded in a 0-th plaintext block in the sequence of plaintext blocks. Refer to FIG. 4 in conjunction with FIG. 5. FIG. 4 is a diagram of a flash memory controller 400 according to another embodiment of the invention. FIG. 5 is a circuit diagram of the multiplier 425A (or 425B) in FIG. 4 according to an embodiment of the invention. The flash memory controller 400 comprises the encryption circuit 105E, the decryption circuit 105D, and a microcontroller 410. In this embodiment, the microcontroller 410 can be used to assign the seed value mentioned above, and is not used to transmit the mode selection signal Mode into the encryption circuit 105E and decryption circuit 105D. The operations of encryption circuit 105E and decryption circuit 105D in FIG. 4 are similar to those of encryption circuit 105E and decryption circuit 105D in FIG. 1, and a difference is that the multiplier 425A is arranged to operate in the first block cipher mode or the second block cipher mode based on the information (i.e. mode selection signal) recorded in the first plaintext block (i.e. the 0-th plaintext block) while the multiplier 425B is arranged to operate in the first block cipher mode or the second block cipher mode based on the information recorded in the decrypted first ciphertext block (i.e. the decrypted 0-th ciphertext block). That is, the multipliers 425A and 425B determine to use which of the first block cipher mode and second block cipher mode for the data of j-th block based on the information of 0-th block data.

In the embodiments, since the multipliers can be bypassed for encryption/decryption of the 0-th block, the multipliers 425A and 425B are suitable for either AES scheme or SM4 scheme in this situation. Thus, the mode selection information/signal can be stored and carried by the 0-th plaintext block or can be generated from a microcontroller. The multiplier 425A can correctly operate for the j-th plaintext block based on either the mode selection signal stored in the 0-th plaintext block or the mode selection signal generated from a microcontroller, and the multiplier 425A can also correctly operate for the j-th plaintext block based on either the mode selection signal stored in the decrypted 0-th ciphertext block corresponding to the 0-th plaintext block or the mode selection signal generated from a microcontroller. The other operations are similar and not detailed for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A flash memory controller, to be coupled between a host device and a flash memory device, comprising:
a microcontroller; and
an encryption circuit, coupled to the microcontroller, comprising:
a first encryption circuit, for encrypting a seed value to generate an encrypted seed value in a first block cipher mode according to a second key;
a second encryption circuit, for encrypting the seed value to generate an encrypted seed value in a second block cipher mode according to the second key;
a multiplier, coupled to the first encryption circuit and the second encryption circuit, for multiplying the encrypted seed value, generated in the first block cipher mode or in the second block cipher mode, with a specific value α^{j} according to a mode selection signal to generate a j-th multiplication result, α being a primitive element corresponding to a polynomial of a finite field multiplier;
a first exclusive-OR (XOR) circuit, coupled to the multiplier, for performing a first XOR operation upon the j-th multiplication result and a j-th plaintext block to generate a first XOR result, a data unit sent from the host device and to be written into the flash memory device being received by the flash memory controller and including a sequence of plaintext blocks in which the j-th plaintext block is included;
a third encryption circuit, coupled to the first XOR circuit, for encrypting the first XOR result to generate an encrypted XOR result in the first block cipher mode according to a first key;
a fourth encryption circuit, coupled to the first XOR circuit, for encrypting the first XOR result to generate the encrypted XOR result in the second block cipher mode according to the first key; and
a second XOR circuit, coupled to the multiplier, the third encryption circuit, and the fourth encryption circuit, for performing a second XOR operation upon the j-th multiplication result and the encrypted XOR result which is generated in the first block cipher mode or in the second block cipher mode so as to generate a second XOR result as a j-th ciphertext block which is written into the flash memory device;
wherein the multiplier operating in the first block cipher mode or in the second block cipher mode is determined by either the mode selection signal generated from the microcontroller or the mode selection signal recorded in a 0-th plaintext block in the sequence of plaintext blocks.

2. The flash memory controller of claim 1, wherein when the multiplier operates in the first block cipher mode, the first encryption circuit and the third encryption circuit are enabled while the second encryption circuit and the fourth encryption circuit are disabled; and, when the multiplier operates in the second block cipher mode, the first encryption circuit and the third encryption circuit are disabled while the second encryption circuit and the fourth encryption circuit are enabled.

3. The flash memory controller of claim 1, wherein the first block cipher mode is associated with an operation for Advanced Encryption Standard, and the second block cipher mode is associated with another different cryptographic standard.

4. The flash memory controller of claim 1, wherein the multiplier is bypassed when generating a 0-th multiplication result, and the encrypted seed value generated in the first block cipher mode or in the second block cipher mode is directly used as the 0-th multiplication result.

5. The flash memory controller of claim 4, wherein the multiplier comprises:
a first multiplexer, having a first input portion and a second input portion, for selecting a sequence of bits, generated from the first encryption circuit and directly inputted to the first input portion, as a sequence of first output bits when the mode selection signal indicates the first block cipher mode, and for performing an order-reversed operation upon another sequence of bits generated from the second encryption circuit to generate and select an order-reversed sequence of bits as the sequence of first output bits when the mode selection signal indicates the second block cipher mode;
a multiplication circuit corresponding to a cipher operation of the first block cipher mode, coupled to the first multiplexer, for multiplying the sequence of first output bits with a sequence of bits representing α to generate a sequence of multiplication result bits;
a second multiplexer, coupled to the multiplication circuit, having a third input portion and a fourth input portion, for directly selecting the sequence of multiplication result bits as a sequence of second output bits which is used as a 1-th multiplication result when the mode selection signal indicates the first block cipher mode, and for performing another order-reversed operation upon the sequence of multiplication result bits to generate and select another order-reversed sequence of bits as the sequence of second output bits which is used as the 1-th multiplication result when the mode selection signal indicates the second block cipher mode.

6. The flash memory controller of claim 5, wherein for generating the j-th multiplication result:
the first multiplexer directly selects a sequence of bits of a (j−1)-th multiplication result as the sequence of first output bits when the mode selection signal indicates the first block cipher mode, and performs the order-reversed operation upon the sequence of bits of the (j−1)-th multiplication result to generate and select the order-reversed sequence of bits as the sequence of first output bits when the mode selection signal indicates the second block cipher mode;
the multiplication circuit corresponding to the cipher operation of the first block cipher mode is used to multiply the sequence of first output bits with the sequence of bits representing α to generate the sequence of multiplication result bits; and
the second multiplexer directly selects the sequence of multiplication result bits as the sequence of second output bits which is used as the j-th multiplication result when the mode selection signal indicates the first block cipher mode, and performs the another order-reversed operation upon the sequence of multiplication result bits to generate and select the another order-reversed sequence of bits as the sequence of second output bits which is used as the j-th multiplication result when the mode selection signal indicates the second block cipher mode.

7. The flash memory controller of claim 1, further comprising:
a decryption circuit, coupled to the microcontroller, comprising:
a fifth encryption circuit, for encrypting the seed value to generate the encrypted seed value in the first block cipher mode according to the second key;
a sixth encryption circuit, for encrypting the seed value to generate the encrypted seed value in the second block cipher mode according to the second key;
another multiplier, coupled to the fifth encryption circuit and the sixth encryption circuit, for multiplying the encrypted seed value, generated in the first block cipher mode or in the second block cipher mode, with the specific value α^{j} according to the mode selection signal to generate another j-th multiplication result;
a third XOR circuit, coupled to the another multiplier, for performing a third XOR operation upon the another j-th multiplication result and the j-th ciphertext block to generate a third XOR result, a data unit read from the flash memory device being received by the flash memory controller and including a sequence of ciphertext blocks in which the j-th ciphertext block is included;
a first decryption circuit, coupled to the third XOR circuit, for decrypting the third XOR result to generate a decrypted XOR result in the first block cipher mode according to the first key;
a second decryption circuit, coupled to the third XOR circuit, for decrypting the third XOR result to generate the decrypted XOR result in the second block cipher mode according to the first key; and
a fourth XOR circuit, coupled to the another multiplier, the first decryption circuit, and the second decryption circuit, for performing a fourth XOR operation upon the another j-th multiplication result and the decrypted XOR result which is generated in the first block cipher mode or in the second block cipher mode so as to generate a fourth XOR result as the j-th plaintext block which is decrypted from the j-th ciphertext block and is to sent to the host device;
wherein the another multiplier operating in the first block cipher mode or in the second block cipher mode is determined by either the mode selection signal generated from the microcontroller or the mode selection signal recorded in a 0-th ciphertext block.

8. A block cipher method of a flash memory controller to be coupled between a host device and a flash memory device, comprising:
providing a first encryption circuit for encrypting a seed value to generate an encrypted seed value in a first block cipher mode according to a second key;
providing a second encryption circuit for encrypting the seed value to generate an encrypted seed value in a second block cipher mode according to the second key;
multiplying the encrypted seed value, generated in the first block cipher mode or in the second block cipher mode, with a specific value α^{j} according to a mode selection signal to generate a j-th multiplication result, α being a primitive element corresponding to a polynomial of a finite field multiplier;
performing a first XOR operation upon the j-th multiplication result and a j-th plaintext block to generate a first XOR result, a data unit sent from the host device and to be written into the flash memory device being received by the flash memory controller and including a sequence of plaintext blocks in which the j-th plaintext block is included;
providing a third encryption circuit for encrypting the first XOR result to generate an encrypted XOR result in the first block cipher mode according to a first key;
providing a fourth encryption circuit for encrypting the first XOR result to generate the encrypted XOR result in the second block cipher mode according to the first key; and
performing a second XOR operation upon the j-th multiplication result and the encrypted XOR result which is generated in the first block cipher mode or in the second block cipher mode so as to generate a second XOR result as a j-th ciphertext block which is written into the flash memory device;
wherein the multiplying step operating in the first block cipher mode or in the second block cipher mode is determined by either the mode selection signal generated from a microcontroller of the flash memory controller or the mode selection signal recorded in a 0-th plaintext block in the sequence of plaintext blocks.

9. The block cipher method of claim 8, further comprising:
when operating in the first block cipher mode, enabling the first encryption circuit and the third encryption circuit and disabling the second encryption circuit and the fourth encryption circuit; and
when operating in the second block cipher mode, disabling the first encryption circuit and the third encryption circuit and enabling the second encryption circuit and the fourth encryption circuit.

10. The block cipher method of claim 8, wherein the multiplying step is bypassed when generating a 0-th multiplication result, and the encrypted seed value generated in the first block cipher mode or in the second block cipher mode is directly used as the 0-th multiplication result.

11. The block cipher method of claim 10, wherein the multiplying step comprises:
providing a first multiplexer for selecting a sequence of bits, generated from the first encryption circuit and directly inputted to the first input portion, as a sequence of first output bits when the mode selection signal indicates the first block cipher mode, and for performing an order-reversed operation upon another sequence of bits generated from the second encryption circuit to generate and select an order-reversed sequence of bits as the sequence of first output bits when the mode selection signal indicates the second block cipher mode;
using a multiplication circuit corresponding to a cipher operation of the first block cipher mode to multiply the sequence of first output bits with a sequence of bits representing α to generate a sequence of multiplication result bits;
providing a second multiplexer for directly selecting the sequence of multiplication result bits as a sequence of second output bits which is used as a 1-th multiplication result when the mode selection signal indicates the first block cipher mode, and for performing another order-reversed operation upon the sequence of multiplication result bits to generate and select another order-reversed sequence of bits as the sequence of second output bits which is used as the 1-th multiplication result when the mode selection signal indicates the second block cipher mode.

12. The block cipher method of claim 11, wherein for generating the j-th multiplication result, the multiplying step further comprises:
using the first multiplexer to directly select a sequence of bits of a (j−1)-th multiplication result as the sequence of first output bits when the mode selection signal indicates the first block cipher mode, and to perform the order-reversed operation upon the sequence of bits of the (j−1)-th multiplication result to generate and select the order-reversed sequence of bits as the sequence of first output bits when the mode selection signal indicates the second block cipher mode;
using the multiplication circuit corresponding to the cipher operation of the first block cipher mode to multiply the sequence of first output bits with the sequence of bits representing α to generate the sequence of multiplication result bits; and
using the second multiplexer to directly select the sequence of multiplication result bits as the sequence of second output bits which is used as the j-th multiplication result when the mode selection signal indicates the first block cipher mode, and to perform the another order-reversed operation upon the sequence of multiplication result bits to generate and select the another order-reversed sequence of bits as the sequence of second output bits which is used as the j-th multiplication result when the mode selection signal indicates the second block cipher mode.

13. The block cipher method of claim 8, further comprising:
providing a fifth encryption circuit for encrypting the seed value to generate the encrypted seed value in the first block cipher mode according to the second key;
providing a sixth encryption circuit for encrypting the seed value to generate the encrypted seed value in the second block cipher mode according to the second key;
using another multiplier to multiply the encrypted seed value, generated in the first block cipher mode or in the second block cipher mode, with the specific value α^{j} according to the mode selection signal to generate another j-th multiplication result;
performing a third XOR operation upon the another j-th multiplication result and the j-th ciphertext block to generate a third XOR result, a data unit read from the flash memory device being received by the flash memory controller and including a sequence of ciphertext blocks in which the j-th ciphertext block is included;
providing a first decryption circuit for decrypting the third XOR result to generate a decrypted XOR result in the first block cipher mode according to the first key;
providing a second decryption circuit for decrypting the third XOR result to generate the decrypted XOR result in the second block cipher mode according to the first key; and
performing a fourth XOR operation upon the another j-th multiplication result and the decrypted XOR result which is generated in the first block cipher mode or in the second block cipher mode so as to generate a fourth XOR result as the j-th plaintext block which is decrypted from the j-th ciphertext block and is to sent to the host device;
wherein the another multiplier operating in the first block cipher mode or in the second block cipher mode is determined by either the mode selection signal generated from the microcontroller or the mode selection signal recorded in a 0-th ciphertext block.
